(19) United States
(12) Patent Application Publication
(10) Pub. No.: US 2020/0255676 A1
(43) Pub. Date: Aug. 13, 2020

(54) HEAT SEALABLE COATING

(71) Applicant: TOPCHIM NV, Wommelgem (BE)

(72) Inventors: Jan-Pieter LUYTEN, Wijnegem (BE); Dirk STANSSENS, Houthalen (BE); Erik JÖNSSON, Schilde (BE)

(21) Appl. No.: 16/642,421

(22) PCT Filed: Aug. 30, 2018
(86) PCT No.: PCT/EP2018/073373

§ 371 Date: Feb. 27, 2020

(30) Foreign Application Priority Data
Aug. 31, 2017 (EP) 17188855.5

(51) Int. Cl. C09D 7/63; C09D 123/08; B65D 3/12; C09D 123/22; C09D 133/08; C09D 109/06

(52) U.S. Cl. CPC C09D 7/63; C09D 123/0853; B65D 3/12; C08K 5/101; C09D 133/08; C09D 109/06; C09D 123/22

(57) ABSTRACT

The present invention relates to a heat sealable and water repellent coating and a substrate comprising said heat sealable and water repellent coating that can be used in the manufacture of drinking cups or food boxes, in particular hot drinking cups or hot food boxes. Said heat sealable and water repellent coating comprises a cyclic imide co-polymer, at least two adhesive binders, of which one of these is a polymer with a Tg lower than −20° C. and a molecular weight above 25000 Da, said polymer being selected from the group comprising natural rubber, polyacrylate, polystyrene butadiene, polybutene, polyisobutene, polyisoprene; preferably natural rubber, and a tackifying agent.

Due to its specific characteristics, the heat sealable and water repellent substrate comprising the coating according to the present invention is biodegradable, recyclable and repulpable.

### FIELD OF THE INVENTION

The present invention relates to a heat sealable coating and a substrate comprising said heat sealable coating that can be used in the manufacture of drinking cups or food boxes, in particular hot drinking cups or hot food boxes. Preferably, the heat sealable coating of the present invention is combined with a water repellent coating, either by mixture or by separate application of the two coatings. Due to its specific characteristics, the heat sealable substrate comprising the coating according to the present invention is recyclable and repulpable.

### BACKGROUND TO THE INVENTION

A heat sealable substrate is normally composed of one or more basic layers and a coating layer having heat sealable characteristics. The substrates can then be sealed to each other or the other substrates just by heating the heat sealable layer and by putting some pressure on the substrates. Alternatively, the substrates have to be treated by a glue. However, this is a more cumbersome process as the glue needs to be applied or even be dried just before the substrates are attached to each other. The use of heat sealable substrates is especially favorable in high speed applications where many articles need to be sealed in a very short time. This is the case for instance in food applications whereby packaging material needs to be sealed once it is formed in the right shape or when the packaging material needs to be closed once it is filled.

Currently, thermoplastic materials are mostly used to create the heat sealability property. Materials such as LDPE, PP are very well suited for this. The polyolefins have the extra advantage of having good barrier properties against for instance water, which helps to protect the goods that are packed in the packaging material. The thermoplastic materials can be used on their own or they can be employed as a laminated layer on another substrate. In the latter, the thermoplastic material is extruded and through a lamination process the material is brought as tiny layer on another substrate. This can be another thermoplastic material or a non-thermoplastic material. An interesting combination is the lamination of a LDPE layer on paper or card board. Paper and card board are cheap materials and can give stiffness to the packaging material, while LDPE provides barrier properties and heat sealability.

This combination is often used in food packaging such as for instance for sandwich boxes, frozen food containers, but also for liquids such as for instance cups. For convenience reasons cups are more and more used as well for hot and cold drinks as for frozen foods. The packaging is developed for one time use applications and after its use this packaging material is considered as waste. Nowadays, there is a general trend to design materials in such a way that after their life time the waste material can be up-graded to a new useful material. With packaging material consisting out of paper or card board and LDPE this is very difficult. It is hard to separate the LDPE from the paper or card board and principally the only useful application of the waste is to incinerate it in order to recuperate the energy.

Previous work of the applicant has led to the development of a heat sealable substrate with good water barrier properties that after its use can be easily recycled to a new material with useful properties (WO2001110498). In particular, a coating comprising a cyclic imide containing polymer in combination with a tackifying agent, one or more binders and an anti-blocking agent is used, thereby not only obtaining a heat sealability but also water barrier properties. The cyclic imide structures are quite unique as they have a high rigidity and polarity, though they have a good hydrophobicity. The high rigidity enables the preparation of polymers with a high glass transition temperature (Tg), which makes sure that good film formation and good adhesion takes place only at elevated temperatures.

Though, the presence of an anti-blocking agent is needed so that the coated paper does not stick to the other side of the paper. On the other hand, the presence of the anti-blocking agents leads to a reduced heat sealability and often the speed of the cup making machine has to be decreased. Furthermore, with the products described in WO201110498 it is possible to make cups but these are only suitable for cold drinks. With hot drinks, the seal of the cup becomes weak and the cups start to leak.

In the present invention, a novel heat sealable coating was developed, said coating comprising at least two adhesive binders, of which one of them is a polymer with a Tg lower than −20° C. and a molecular weight above 25000 Da, for example natural rubber, and a tackifying agent. Typical for the present coating is that is does not need to comprise an anti-blocking agent, and therefore the coated board is suitable for high speed cup machines and the cups made are suitable for hot drink applications. Further, the coating according to the present invention can be combined with a water repellent coating, either by mixing the two coatings and applying them as one single coating, or by applying the two coatings separately.

### SUMMARY OF THE INVENTION

In a first embodiment, the present invention is directed to a heat sealable coating comprising at least two adhesive binders present in a total amount between 50 and 80 wt %, and a tackifying agent present between 5 and 30 wt %. Said coating is typically characterized in that at least one adhesive binder is present in between 15 and 45 wt % and said adhesive binder is a polymer with a Tg lower than −20° C. and a molecular weight above 25000 Da. Further, the other one or more adhesive binder(s) are each independently present in between 15 and 65 wt %. Said adhesive binders are selected from styrene butadiene, dispersions of polyacrylate, polystyrene acrylate, polyurethane, polyvinyl acetate, polyethylene acetate, ethylene vinylchloride co-polymers, polyethylene, polypropylene, polyesters, co-polymers of styrene/maleic anhydride salts, or mixtures thereof; in particular polyvinyl acetate. In a further embodiment, the polymer with a Tg lower than −20° C. and a molecular weight above 25000 Da is selected from the group comprising natural rubber, polyacrylate, styrene butadiene, polybutene, polyisobutene, polyisoprene; preferably natural rubber. Even further, the polymer with a Tg lower than −20° C. and a molecular weight above 25000 Da is present in between 15% and 40 wt %; in particular in between 15 wt % and 35 wt %.

The heat sealable and water repellent coating of the present invention is further characterized in that the tackifying agent is present in between 5 and 30 wt %. Even more in particular the tackifying agent is present in between 10 and 30 wt %; even more in particular in between 15 and 25 wt %. Tackifiers are usually resinous materials that help increasing the tack when substrates are brought into contact. This can be especially needed when adhesion on low surface energy substrates is required. Said tackifying agent can be selected from acrylic emulsions, polyethylene acrylate, rosin resin and its derivatives, low molecular weight polyethylenes; in particular polyethylene acrylate.

Typical for the present invention, is that no anti-blocking agent is needed to be present in the coating. Thus, in a further embodiment, the heat sealable coating according to the present invention does not comprise an anti-blocking agent. Typical examples of such anti-blocking agents are organic or inorganic pigments. Organic pigments are for instance hollow spheres based on partially crosslinked polystyrene. Inorganic pigments can be for instance calcium carbonate, talcum or clay.

The heat sealable coating according to the present invention is characterized by the presence of at least two adhesive binders in a total amount between 50 and 80 wt %; the presence of a tackifying agent between 5 and 30 wt %. At least one of these two adhesive binders in the coating is a polymer with a Tg lower than −20° C. and a molecular weight above 25000 Da. Said polymer is selected from the group comprising natural rubber, polyacrylate, styrene butadiene, polybutene, polyisobutene, polyisoprene; preferably natural rubber, even more preferably natural rubber latex. The adhesive binder being a polymer with a Tg lower than −20° C. and a molecular weight above 25000 Da is present between 15 and 45 wt %, preferably between 15 and 40 wt %, more preferably between 15 and 35 wt %.

In a particular embodiment the heat sealable coating according to the present invention is characterized by the presence of at least two adhesive binders in a total amount between 50 and 80 wt %; the presence of a tackifying agent between 5 and 30 wt %; and in that it does not comprise an anti-blocking agent. At least one of these two adhesive binders in the coating is a polymer with a Tg lower than −20° C. and a molecular weight above 25000 Da. Said polymer is selected from the group comprising natural rubber, polyacrylate, polystyrene butadiene, polybutene, polyisobutene, polyisoprene; preferably natural rubber, even more preferably natural rubber latex. The adhesive binder being a polymer with a Tg lower than −20° C. and a molecular weight above 25000 Da is present between 15 and 45 wt %, preferably between 15 and 40 wt %, more preferably between 15 and 35 wt %.

The heat sealable coating according to the present invention thus comprises at least two adhesive binders, of which one adhesive binder is a polymer with a Tg lower than −20° C. and a molecular weight above 25000 Da, said polymer being selected from the group comprising natural rubber, polyacrylate, styrene butadiene, polybutene, polyisobutene, polyisoprene; preferably natural rubber. The other one or more adhesive binder(s) are selected from styrene butadiene, dispersions of polyacrylate, polystyrene acrylate, polyurethane, polyvinyl acetate, polyethylene acetate, ethylene vinylchloride co-polymers, polyethylene, polypropylene, polyesters, co-polymers of styrene maleic anhydride salts, or mixtures thereof; in particular polyvinyl acetate. Said other adhesive binder(s) are each independently present in the coating between 15 wt % and 65 wt %, preferably between 15 wt % and 40 wt %, more preferably between 15 and 35 wt %.

As already outlined herein above, the coating according to the present invention comprises at least two adhesive binders present in a total amount between 50 and 80 wt %, wherein at least one of said adhesive binders is a polymer with a Tg lower than −20° C. and a molecular weight above 25000 Da, said polymer being selected from the group comprising natural rubber, polyacrylate, styrene butadiene, polybutene, polyisobutene, polyisoprene; preferably natural rubber. In a further embodiment, the amount of the polymer with a Tg lower than −20° C. and a molecular weight above 25000 Da, preferably natural rubber, and the amount of the other one or more adhesive binder(s) is equal, for example 25 wt %, 30 wt %, 35 wt %, or 40 wt %, preferably 25 wt % or 30 wt %. In a preferred embodiment, the heat sealable coating comprises 30 wt % natural rubber and 30 wt % polyvinyl acetate. In a particular embodiment the coating according to the present invention comprises only two adhesive binders present in a total amount between 50 and 80 wt %, wherein one of said adhesive binders is a polymer with a Tg lower than −20° C. and a molecular weight above 25000 Da, said polymer being selected from the group comprising natural rubber, polyacrylate, styrene butadiene, polybutene, polyisobutene, polyisoprene; preferably natural rubber; the other adhesive binder is selected from styrene butadiene, dispersions of polyacrylate, polystyrene acrylate, polyurethane, polyvinyl acetate, polyethylene acetate, ethylene vinylchloride co-polymers, polyethylene, polypropylene, polyesters, or co-polymers of styrene maleic anhydride salts; in particular polyvinyl acetate; and wherein the amount of the polymer with a Tg lower than −20° C. and a molecular weight above 25000 Da, preferably natural rubber, and the amount of the other adhesive binder is equal, for example 25 wt %, 30 wt %, 35 wt %, or 40 wt %, preferably 25 wt % or 30 wt %. In a preferred embodiment, the heat sealable coating comprises 30 wt % natural rubber and 30 wt % polyvinyl acetate.

The heat sealable coating according to the present invention can further be combined with a water repellent coating, either by mixing together the two coatings and applying these two coatings as one single coating simultaneously, or by applying the two coatings separately. The water repellent coating comprises a cyclic imide co-polymer, or a silicone, a polyethylene emulsion, a polypropene emulsion or a polyolefin, with a melting point above 100° C. Therefore, in a specific embodiment of the present invention, the heat sealable coating according to the present invention further comprises a cyclic imide co-polymer present in between 12 and 30 wt %. In an even more preferred embodiment, the heat sealable coating comprises a cyclic imide co-polymer present between 12 and 25 wt %.

In yet another embodiment, the heat sealable coating according to the present invention further comprises silicone, a polyethylene emulsion, a polypropene emulsion or a polyolefin, all with a melting point above 100° C., or a combination of one or more of these compounds, present in between 12 and 30 wt %; preferably present in between 12 and 25 wt %.

The heat sealable coating as described herein can be applied on different substrates. Typical substrates are paper, card board, wood, thermoplastic and thermoset materials, glass textile, leather and metals, preferably paper and card board.

Thus in a further embodiment the invention relates to a heat sealable substrate consisting of a substrate coated with a layer of a heat-sealable coating as described herein. In particular, the present invention discloses a heat sealable substrate for making drinking cups or food boxes comprising a substrate coated with a coating according to the present invention and as outlined above. In a particular embodiment, the substrate is coated with a heat sealable coating comprising at least two adhesive binders present in a total amount between 50 and 80 wt %, and a tackifying agent present between 5 and 30 wt %. In said coating, at least one adhesive binder is a polymer with a Tg lower than −20° C. and a molecular weight above 25000 Da, said polymer being selected from the group comprising natural rubber, polyacrylate, styrene butadiene, polybutene, polyisobutene, polyisoprene; preferably natural rubber, wherein said polymer is present in between 15 and 45 wt %, and the other one or more adhesive binder(s) are each independently present in between 15 and 65 wt % and are selected from styrene butadiene, dispersions of polyacrylate, polystyrene acrylate, polyurethane, polyvinyl acetate, polyethylene acetate, ethylene vinylchloride co-polymers, polyethylene, polypropylene, polyesters, co-polymers of styrene maleic anhydride salts, or mixtures thereof; in particular polyvinyl acetate. In a further embodiment, the heat sealable and water repellent substrate comprises a heat sealable and water repellent coating as herein provided, wherein the tackifying agent is selected from polyacrylic emulsions, polyethylene acrylate, rosin resin and its derivatives, low molecular polyethylenes; in particular polyethylene acrylate. In a particular embodiment the present invention provides a heat sealable substrate coated with a layer of a heat-sealable coating comprising only two adhesive binders present in a total amount between 50 and 80 wt %, and a tackifying agent present between 5 and 30 wt %; wherein one of said adhesive binders is a polymer with a Tg lower than −20° C. and a molecular weight above 25000 Da, said polymer being selected from the group comprising natural rubber, polyacrylate, styrene butadiene, polybutene, polyisobutene, polyisoprene; preferably natural rubber; the other adhesive binder is selected from styrene butadiene, dispersions of polyacrylate, polystyrene acrylate, polyurethane, polyvinyl acetate, polyethylene acetate, ethylene vinylchloride co-polymers, polyethylene, polypropylene, polyesters, or co-polymers of styrene maleic anhydride salts; in particular polyvinyl acetate; the tackifying agent is selected from acrylic emulsions, polyethylene acrylate, rosin resin and its derivatives, low molecular polyethylenes; in particular polyethylene acrylate; and wherein the amount of the polymer with a Tg lower than −20° C. and a molecular weight above 25000 Da, preferably natural rubber, and the amount of the other adhesive binder is equal, for example 25 wt %, 30 wt %, 35 wt %, or 40 wt %, preferably 25 wt % or 30 wt %. In a preferred embodiment, the heat sealable coating comprises 30 wt % natural rubber and 30 wt % polyvinyl acetate as adhesive binders.

Also typical for the coating of the heat sealable and water repellent substrate is that it does not need to comprise an anti-blocking agent. Thus in an embodiment of the present invention the heat sealable and water repellent substrate comprises a heat sealable coating according to the present invention characterized in that it does not comprise an anti-blocking agent.

In still another embodiment, the heat sealable substrate comprises a coating wherein at least one adhesive binder is a polymer with a Tg lower than −20° C. and a molecular weight above 25000 Da, said polymer being selected from the group comprising natural rubber, polyacrylate, styrene butadiene, polybutene, polyisobutene, polyisoprene; preferably natural rubber, wherein said polymer is present in between 15 and 45 wt %, in particular 15 and 40 wt %, in particular 15 and 35 wt %.

In a further embodiment, the heat sealable and water repellent substrate comprises a coating wherein the tackifying agent is present in an amount between 5 and 30 wt %; in particular in an amount between 10 and 30 wt %; more in particular in an amount between 15 and 25 wt %.

In a specific embodiment, the heat sealable substrate according to the present invention, is a heat sealable and water repellent substrate. In said embodiment, the substrate comprises a heat sealable and water repellent coating comprising at least two adhesive binders present in a total amount between 50 and 80 wt % and as described herein above, a tackifying agent present in between 5 and 30 wt %, and a cyclic imide co-polymer present in between 12 and 30 wt %; in particular in between 12 and 25 wt %. In another embodiment, the heat sealable and water repellent substrate comprises a heat sealable coating comprising at least two adhesive binders present in a total amount between 50 and 80 wt % as described herein above, a tackifying agent present in between 5 and 30 wt %, and a silicone, a polyethylene emulsion, a polypropene emulsion, or a polyolefin, all with a melting temperature above 100° C., present in between 12 and 30 wt %; in particular in between 12 and 25 wt %.

In yet another embodiment, the present invention relates to a heat sealable and water repellent substrate for making drinking cups or food boxes comprising a substrate that is first coated with a water repellent coating and thereafter coated with a heat sealable coating according to the present invention. The water repellent coating comprises a cyclic imide co-polymer present in between 12 and 30 wt %; preferably in between 12 and 25 wt %; or a silicone, a polyethylene emulsion, a polypropene emulsion or a polyolefin all with a melting temperature above 100° C., or a combination of one of these, said compounds present in between 12 and 30 wt %; preferably in between 12 and 25 wt %.

The heat sealable substrate or the heat sealable and water repellent substrate for making drinking cups or food boxes according to the present invention is preferably paper or card board.

Also according to the present invention, the drinking cups or food boxes are hot drinking cups or hot food boxes.

Further, also the use of a heat sealable substrate as disclosed herein above for making drinking cups or food boxes is disclosed; in particular for making hot drinking cups or hot food boxes.

The present invention further discloses the use of a substrate in the manufacture of a heat sealable substrate for making drinking cups or food boxes; in particular for making hot drinking cups of hot food boxes. Said substrate is coated with a coating according to the present invention. In particular, the substrate is coated with a heat sealable coating comprising at least two adhesive binders present in a total amount between 50 and 80 wt %; and a tackifying agent present between 5 and 30 wt %, in particular between 10 and 30 wt %; more in particular between 15 and 25 wt %. The coating of the substrate is further characterized in that at least one adhesive binder is a polymer with a Tg lower than −20° C. and a molecular weight above 25000 Da, said polymer being selected from the group comprising natural rubber, polyacrylate, styrene butadiene, polybutene, polyisobutene, polyisoprene; preferably natural rubber, said polymer being present between 15 and 45 wt %, in particular between 15 and 40 wt %, more in particular between 15 and 25 wt %; the other adhesive binder(s) are present in between 15 and 65 wt % and are selected from styrene butadiene, dispersions of polyacrylate, polystyrene acrylate, polyurethane, polyvinyl acetate, polyethylene acetate, ethylene vinylchloride co-polymers, polyethylene, polypropylene, polyesters, co-polymers of styrene maleic anhydride salts, or mixtures thereof, in particular polyvinyl acetate. In a further embodiment, the substrate is coated with the heat sealable coating as described herein above, said coating further comprising a cyclic imide co-polymer present in between 12 and 30 wt %; preferably in between 12 and 25 wt %. In another embodiment, the substrate is coated with a silicone, a polyethylene emulsion, or a polyolefin with a melting temperature above 100° C., present in between 12 and 30 wt %; in particular in between 12 and 25 wt %.

### DETAILED DESCRIPTION OF THE INVENTION

It is an object of the present invention to provide a heat sealable coating and corresponding substrate that is fully recyclable and repulpable and that can be used in fast sealing applications. In addition, the heat sealable coating according to the present invention ensures the maintenance of viscosity at high temperatures, good sealability and good anti-blocking properties. Further, the heat sealable coating of the present invention can be combined with a water repellent coating, thereby providing a heat sealable and water repellent coating that can be applied on a substrate creating a heat sealable and water repellent substrate for making drinking cups or food boxes.

As already outlined herein above, the heat sealable and water repellent coating according to the present invention comprises at least two adhesive binders and a tackifying agent. The coating layer is typically characterized in that at least one adhesive binder is a polymer with a Tg lower than −20° C. and a molecular weight above 25000 Da. It has surprisingly been found that by using such a polymer with a Tg lower than −20° C. and a molecular weight above 25000 Da, there is no need to add an anti-blocking agent to the heat sealable coating. As a result, the overall amount of binder can be increased which leads to a faster heat sealing process and to the possibility to use the cups for hot drink applications.

In the development of a heat sealable and optionally water repellent coating, a balanced equilibrium always needs to be found between the heat sealabilty and the blocking capacity of the coating. This is particularly important in the development of coatings used in the production of hot drinking cups or hot food boxes, since these are generally produced using fast-sealing applications. In these applications, also a good tack is essential.

Whereas the use of a polymer with a low Tg in a coating is beneficial for the heat sealability of said coating, it will be negative for the blocking of said coating. In such cases, an anti-blocking agent needs to be added because tacking of the coating occurs already at a low temperature. The presence of an anti-blocking agent is thus typically needed to prevent sticking of the coated paper to the other side of the paper. On the other hand, the presence of the anti-blocking agents leads to a reduced heat sealability, leading to weakening of the seal when used for hot drinking cups, and often the speed of the cup making machine must be decreased. For example, as described in WO2011110498, in case a low Tg adhesive binder is added to a coating, also an anti-blocking agent needs to be added to overcome blocking problems.

In contrast, and according to the present invention, when using a polymer with a high Tg in a coating, the substrate with said coating can be used at a higher temperature, though without having any tack. For the production of drinking cups or food boxes a considerable tack is essential, in particular in fast-sealing applications, and therefore a balanced equilibrium between heat sealability, tacking capacity and blocking capacity is crucial.

In the present invention, the inventors surprisingly found that by using a combination of at least two adhesive binders and a tackifying agent, wherein at least one adhesive binder is a polymer that has a Tg lower than −20° C. and a molecular weight above 25000 Da, said polymer being selected from the group comprising natural rubber, polyacrylate, styrene butadiene, polybutene, polyisobutene, polyisoprene; preferably natural rubber, there is no need to add an anti-blocking agent to the heat sealable coating. This is unexpected since these polymers have a low Tg (lower than −20° C., in particular natural rubber has a Tg of −40° C.), and thus one should expect that the addition of an anti-blocking agent is necessary as well. In contrast, and as also shown in the examples herein below, the inventors have found that no anti-blocking agent is needed when a coating is used that comprises at least two adhesive binders and a tackifying agent, wherein at least one adhesive binder is a polymer with a Tg lower than −20° C. and a molecular weight above 25000 Da, said polymer being selected from the group comprising natural rubber, polyacrylate, polystyrene butadiene, polybutene, polyisobutene, polyisoprene; preferably natural rubber.

As already indicated above, the heat sealable coating according to the present invention is by the presence of at least two adhesive binders in a total amount between 50 and 80% and the presence of a tackifying agent between 5 and 30%. At least one of these two adhesive binders in the coating is a polymer with a Tg lower than −20° C. and a molecular weight above 25000 Da, said polymer being selected from the group comprising natural rubber, polyacrylate, styrene butadiene, polybutene, polyisobutene, polyisoprene; preferably natural rubber, preferably natural rubber latex. Natural rubber includes all materials made from or containing natural rubber latex. Natural rubber refers to natural rubber latex, dry natural rubber, and synthetic latex or synthetic rubber that contains natural rubber in its formulation. Natural rubber latex refers to a milky fluid that consists of extremely small particles of rubber obtained from plants, mainly from the rubber tree, dispersed in an aqueous medium. The most common source of natural rubber latex is the Brazilian rubber tree, Hevea brasiliensis. The main compound of natural rubber latex is cis-1,4-polyisoprene.

Due to the presence of natural rubber, the degree of bio-renewability of the coating is substantially increased. Further the natural rubber biodegrades much faster than a synthetic binder such as polystyrene acrylate or polyethylene.

The other one or more adhesive binder(s) are selected from styrene butadiene, dispersions of polyacrylate, polystyrene acrylate, polyurethane, polyvinyl acetate, polyethylene acetate, ethylene vinylchloride co-polymers, polyethylene, polypropylene, polyesters, co-polymers of styrene maleic anhydride salts, or mixtures thereof; in particular polyvinyl acetate. Said other adhesive binder(s) are each independently present in the coating between 15 wt % and 45 wt %, preferably between 15 wt % and 40 wt %, more preferably between 15 and 35 wt %.

The heat sealable coating according to the present invention also comprises a tackifying agent. This tackifying agent is present in an amount between 5 and 30%, in particular in an amount between 10 and 30%, even more in particular in an amount between 15 and 25%. Tackifiers are usually resinous materials that help increasing the tack when substrates are brought into contact. This can be especially needed when adhesion on low surface energy substrates is required. Examples of tackifiers can be polyacrylic emulsions, polyethylene acrylate emulsions, rosin derivatives, or low molecular weight polyethylenes.

The heat sealable coating according to the present invention can further be combined with a water repellent coating. To this end, a water repellent coating can be added to the heat sealable coating according to the present invention, thereby creating one single coating mixture, where after this heat sealable and water repellent coating mixture is be applied as one mixture on a particular substrate. On the other hand, a water repellent coating can be applied first on a substrate, whereafter the heat sealable coating according to the different embodiments of the invention is applied. In a further embodiment, the water repellent coating can be combined with a filler coating that is applied first on a substrate, followed by the application of the heat sealable coating according to the different embodiments of the present invention.

The water repellent coating can be any coating that shows water repellency characteristics. In a preferred embodiment, the water repellent coating comprises a cyclic imide co-polymer. In a further embodiment, the present invention relates therefore to a heat sealable coating comprising at least two adhesive binders present in an total amount between 50 and 80%, a tackifying agent present in between 50 and 30% and a cyclic imide co-polymer present in between 12 and 30%, in particular in between 12 and 25%. Said cyclic imide is present as part of a polymer. These polymers can be made first and then be dissolved in a suitable solvent or the polymers can be polymerized directly in a suitable solvent. When water is used as a solvent often internal or external surfactants need to be added to keep the polymers stabilized in the water phase.

One way of making cyclic imide containing polymers is by co-polymerization of unsaturated cyclic imides with vinylic co-monomers. Examples of unsaturated cyclic imides are maleimide, itaconimide, citraconimide, succinimide and 2,3 dialkylmaleimides. Suitable vinyl monomers for use in the copolymer include vinyl aromatic monomers (such as styrene, alpha-methyl styrene, vinyl toluene and indene), mono-olefinic unsaturated hydrocarbons (such as ethylene, propylene and isobutylene), alpha-beta-unsaturated carboxylic esters (such as acrylate esters (like ethylacrylate, butylacrylate and 2-ethylhexylacrylate), methacrylate esters (like methylmethacrylate, ethylmethacrylate and 2-hydroxyethylmethacrylate) and maleate diesters (like dioctylmaleate)), halogenated olefins (such as vinyl chloride and vinylidene chloride and mixtures thereof. Preferably the co-polymer contains readily commercially available styrene or alpha-methyl styrene, although the presence of styrene monomer units is most preferred. By the use of a cyclic imide in the coated substrate there is not only obtained a heat sealability but also water barrier or water repellent properties. The cyclic imide structures are quite unique as they have a high rigidity and polarity, though they have a good hydrophobicity. The high rigidity enables the preparation of polymers with a high glass transition temperature (Tg), which makes sure that good film formation and good adhesion takes place only at elevated temperatures. A higher Tg is also beneficial for the non-sticky behaviour of the applied coating. The higher the Tg of the polymer, the higher the substrate can be used without having tack. The high polarity of the cyclic imide groups is advantageous for providing good interaction with other substrates and hence good adhesion. The good hydrophobicity of the cyclic imide will make sure that a good water barrier property can be obtained.

Preferably use is made of a co-polymer in which the cyclic imide monomer content ranges between 5-95 mole %, more preferably between 15 and 50 mole %.

Another convenient way of obtaining cyclic imide containing polymers is by transforming cyclic anhydride containing polymers with ammonia or an alkylamine. Cyclic anhydride containing polymers can for instance be obtained by co-polymerization of unsaturated cyclic anhydrides with vinylic co-monomers. Typical examples of unsaturated cyclic anhydrides are maleic anhydride, itaconic anhydride, citraconic anhydride and 2,3 dialkyl maleic anhydride. Suitable vinyl monomers for use in the co-polymer include vinyl aromatic monomers (such as styrene, alpha-methyl styrene, vinyl toluene and indene), mono-olefinic unsaturated hydrocarbons (such as ethylene, propylene and isobutylene), alpha-beta-unsaturated carboxylic esters (such as acrylate esters (like ethylacrylate, butylacrylate and 2-ethylhexylacrylate), methacrylate esters (like methylmethacrylate, ethylmethacrylate and 2-hydroxyethylmethacrylate) and maleate diesters (like dioctylmaleate), halogenated olefins (such as vinyl chloride and vinylidene chloride) and mixtures thereof. Preferably the co-polymer contains readily commercially available styrene or alfa-methyl styrene, although the presence of styrene monomer units is most preferred.

It is advantageous that the cyclic imide containing polymer has a high Tg, preferably between 40° C. and 250° C., more preferably between 100° C. and 220° C.

The heat sealable coating according to the present invention can thus be combined with a water repellent coating, for example a coating comprising a cyclic imide co-polymer, a silicone, a polyethylene emulsion, a polypropene emulsion, or a polyolefin, all with a melting point above 100° C. Said water repellent coating should show upon drying good water repellency, for example by using products having a core-shell structure, whereby the shell has a cyclic imide containing product or a silicone, a polyethylene emulsion, a polypropene emulsion, or a polyolefin, with a melting point above 100° C. and the core is a non-water soluble product. Such products are for instance vegetable oils, waxes, rosin gums and derivatives, oligomers and polymers of ethylene, propylene, butene, butadiene and mixtures thereof. The higher the content of the aliphatic groups in the core-shell particles, the better will be the water repellency of the resultant coating.

Furthermore, the described particles are sub-micron-sized so that the resultant coating will have a sub-micron-roughness. This leads to an enhancement of the surface tension properties. Hydrophobic products such as for example cyclic imide containing polymers will show super hydrophobicity if the resultant coating has a sub-micron roughness. This is of particular interest when the substrate is paper or card board as these materials have a tendency to take up water quite easily due to their porous character and the presence of many hydrophilic moieties.

The cyclic imide containing polymers for use in the manufacturing of a water repellent coating as described herein, are particularly made from the imidisation reaction of a co-polymer of a cyclic anhydride and vinyl monomers, having a cyclic anhydride (CA) content between 22 and 50 mole %, with an ammonium (NH₃) solution in an CA:NH₃ ratio of between 1.4:1 and 1:1.2 at an elevated temperature till at least 50% of the CA is imidised into the imide; more in particular from the imidisation reaction of a polystyrene maleic anhydride with a maleic anhydride (MA) content of between 22 and 34% using an ammonium (NH₃) solution in an MA:NH₃ ratio between 1.4:1 to 1:1.2 at an elevated temperature till at least 50% of the MA is imidised into maleimide, said cyclic imide containing polymer further being characterized in having a particle size between and about 25-150 nm; a solid content of between and about 25-45 wt %; and a pH of between 6.0 and 9.0.

In an even further embodiment the aforementioned imidisation reaction is performed in the presence of a non-water soluble product, such as for example an oil, an alkane, a terpene or polyolefin or a wax; yielding core-shell particles wherein the shell consists of the cyclic imide containing polymer and the core of the non-water soluble products, said core-shell particles having a solid content between 45-65 wt %; a particle size of between and about 110-150 nm; and a pH of between and about 6.0-9.0.

The heat sealable coating as described herein can be applied on different substrates. Typical substrates are paper, card board, wood, thermoplastic and thermoset materials, glass textile, leather and metals, preferably paper and card board.

The coating layer can be applied on the substrate by typical coating techniques such as spraying, smearing dipping, printing, rolling and painting. For paper and car board applications, coating layers are mostly applied by a blade coater, a knife coater, a curtain coater, a size press or a film press. Once applied, the coating can be dried to the air or a more rapid drying can be achieved by bringing the coated substrate under infra-red lamps or in an oven. A man skilled in the art will make sure that the temperature or the residence time is no too high so that the dried coating will not stick to each other and that the coating will retain its heat sealability properties. The amount of coating applied on the substrate will be dependent on the type of carrier layer, i.e. substrate to be coated and on the required adhesion to be achieved between the substrates. For porous materials, a higher amount of coating will be needed. For paper and card board usually a layer of 2 to 25 gram coating per square meter could be employed, but preferably a layer between 5 and 20 gram per square meter is applied, even more preferably a layer between 8 and 14 gram. A thinner layer is beneficial as it will reduce the weight of the packaging material and will reduce costs, while a thicker layer might be necessary to increase the adherence during the heat sealing.

It is also possible to apply multiple coating layers on the carrier layer, i.e. substrate. Especially when porous materials are treated it is interesting to apply first a coating layer that closes the pores of the substrate, such as a filler layer. Preferably, this coating layer forms a closed film. A typical film would be formed from a formulation containing a polystyrene butadiene latex or polyacrylic dispersion that may contain fillers and pigments up to 95%. Preferably the amount of filler is between 20 and 80 wt %. This formulation may also contain some water repellency agents, such as for instance waxes or the cyclic imide containing products as described above, but the amounts should be limited in order to allow the application of a second layer containing the cyclic imide, adhesive binders and tackifying agent that will provide the heat sealability properties.

The coated substrate can be sealed to another coated substrate, but it is also possible to heat seal the coated substrate with a non-treated substrate. In case the non-treated substrate is not adhering well to the coated substrate, usually, the application of a tiny layer of coating according the present application, for instance 1 to 3 gram per square meter, is sufficient to make the substrate good sealable.

The coated substrate can be sealed by the classical processes such as the ones based on for instance hot air and ultra-son. During the heating a pressure is applied on the substrates to improve the adherence.

In case paper or card board is used as carrier layer it has been found that the coated material according to this invention is repulpable. This has a major impact on the costs and the environmental friendliness of the packaging material. First of all, during the formation of the shaped packaging material, there is some left over paper or card board that can be brought back to the pulp machines. Secondly, the used packaging material will find a second life as recycled paper or card board.

The invention further relates to a coating layer that shows a good water repellency. A coating layer with good heat sealability and good water repellency can substitute thermoplastic layers such as polyethylene and polypropylene. These thermoplastic layers often disturb the recycling process of the substrates that are treated with these layers.

The heat sealable layer according to the present invention can be brought on the substrate by lamination process or by a coating process. Preferably, the application is done by bringing the compound on a substrate out of a solvent. By doing so thinner layers can be put on the substrate compared to a lamination process. Even more preferably, the solvent is primarily water. Water has the advantage to be non-toxic, non-flammable and not to contribute to the exhaust of volatile organic compounds. Furthermore, in many industrial applications machines are so designed that no organic solvents can be used at all. The treated substrates have a high stability, do not stick to other materials, but at high temperatures the products can be sealed to each other or to other materials.

### EXAMPLES

### Example 1

Preparation of Cyclic Imide Containing Polymer with a Paraffin Encapsulated

To a 1 litre double walled, oil heated autoclave, having an anchor stirrer, 120 g of a polystyrene maleic anhydride (SMA) (grade: 26080; from Polyscope, the Netherlands) and 400 g of water were added. The SMA had a maleic anhydride content of 26 mole % and a molecular weight of 80.000 g/mole. To this reaction mixture was added 280 g of paraffin wax with a melting point of 57 C and 21.7 g of a 25% ammonia solution so that the maleic anhydride (MA):NH₃ ratio was about 1:1. The temperature was raised to 160° C. and this temperature was maintained during 4 hours. Thereafter, the reaction mixture was slowly cooled down to room temperature. A polymer dispersion was obtained having a solid content of approximately 57 wt. %, the particle size being between 100 and 140 nm. The pH value was 7.2, indicating an almost complete conversion of the maleic anhydride groups into maleimides.

### Example 2: Coating Formulation 1

In a closed recipient 100 g Primacor 59801, a polyethylene acrylate from DOW Chemical, was dispersed in water by treating the polymer at 120° C. with 185 g of water and 0.35 equivalent of ammonia. To this dispersion 63 grams of Mowilith DC (from Celanese), 83 grams of Vytex (from Centrotrade), 179 grams of Acronal S514 (from BASF) and 131 grams of the polymer dispersion of example 1 is added.

### Example 3: Coating Formulation 2

In a closed recipient 100 g Primacor 59801, a polyethylene acrylate from DOW Chemical, was dispersed in water by treating the polymer at 120° C. with 185 g of water and 0.35 equivalent of ammonia. To this dispersion 216 grams of Mowilith DC (from Celanese), 201 grams of Vytex (from Centrotrade) and 106 grams of the polymer dispersion of example 1 is added.

### Example 4: Coating Formulation 3

In a recipient 286 grams of Vytex (from Centrotrade) was added. To this dispersion 271 grams of Acronal S514 (from BASF), 81 grams of Mowilith DC (from Celanese) and 174 grams of the polymer dispersion of example 1 is added.

### Example 5: Coating Formulation 4

In a closed recipient 100 g Primacor 59801, a polyethylene acrylate from DOW Chemical, was dispersed in water by treating the polymer at 120° C. with 185 g of water and 0.35 equivalent of ammonia. To this dispersion 357 grams of Mowilith DC (from Celanese), 67 grams of Vytex (from Centrotrade) and 105 grams of the polymer dispersion of example 1 is added.

### Example 6: Coating Formulation 5

In a closed recipient 100 g Primacor 59801, a polyethylene acrylate from DOW Chemical, was dispersed in water by treating the polymer at 120° C. with 185 g of water and 0.35 equivalent of ammonia. To this dispersion 216 grams of Mowilith DC (from Celanese), 261 grams of DXA.4226 (from Vanora) and 106 grams of the polymer dispersion of example 1 is added.

### Example 7: Coating Formulation 6

In a closed recipient 100 g Primacor 59801, a polyethylene acrylate from DOW Chemical, was dispersed in water by treating the polymer at 120° C. with 185 g of water and 0.35 equivalent of ammonia. To this dispersion 71 grams of Mowilith DC (from Celanese), 333 grams of Vytex (from Centrotrade) and 105 grams of the polymer dispersion of example 1 is added.

### Example 8: Coating Formulation 7

In a recipient 123 grams of Acronal S514 (from BASF) was added. To this dispersion 57 grams of a talcum slurry (from Imerys) and 20 grams of polymer dispersion of example 1 was added.

### Example 9: Coating Formulation 8

In a closed recipient 100 g Primacor 59801, a polyethylene acrylate from DOW Chemical, was dispersed in water by treating the polymer at 120° C. with 185 g of water and 0.35 equivalent of ammonia. To this dispersion 183 grams of Mowilith DC (from Celanese), 241 grams of DXA.4226 (from Vanora), 120 grams of Acronal S940 (from BASF) and 21 grams of Lumiten 1-SC (from BASF) is added.

The coating formulations 1-6 were applied on Cupforma Natura card board (from StoraEnso), having a weight of 232 gram per square meter (gsm). 16 gsm of coating layer was applied on only one side of the cup stock paper. The Cobb1800 value of the coated cup stock paper amounted from 4- to 10 gram water per square meter. This coating layer provides good water repellence of the cup stock paper.

Coating formulation 7 was applied on Cupforma Natura card board (from StoraEnso), having a weight of 232 gram per square meter (gsm). 5 gsm of coating layer was applied on only one side of the cup stock paper. This is called the precoated paper. The coating formulation 8 was applied with a coating weight of 10 gsm on top of said precoated paper. The Cobb1800 value of the coated cup stock paper amounted to 18 gram water per square meter. This coating layer provides good water repellence of the cup stock paper.

The cup stock was sealed with the W-3000(A) apparatus from Wu-Hsing Electronics Ltd. All coated papers were sealed within 0.75 seconds at 150° C. and 6 bar. Sealability was measured as a function of fiber tear.

Sealability, blocking and suitability for the use in hot cups for each coating formulation are represented in Table 1.

TABLE 1
Characteristics of each coating formulation

| | Coating formulation | | | | | | |
|---|---|---|---|---|---|---|---|
| | 1 | 2 | 3 | 4 | 5 | 6 | 8 |
| Sealability | 5 | 4 | 0 | 0 | 5 | 5 | 5 |
| Blocking | A | A | NA | A | A | NA | A |
| Hot cups | NS | S | NS | NS | S | S | S |

Sealability: Scale 0-5: no seal - perfect seal
S: Suitable
NS: Not suitable
A: Acceptable
NA: Not acceptable

1. A heat sealable coating comprising:
at least two adhesive binders present in a total amount between 50 and 80 wt %; and
a tackifying agent present between 5 and 30 wt %,
at least one adhesive binder present in an amount between 15 and 45 wt % and is a polymer with a Tg lower than −20° C. and a molecular weight above 25000 Da; and
wherein the other adhesive binder(s) are each independently present in between 15 and 65 wt % and are selected from styrene butadiene, dispersions of polyacrylate, polystyrene acrylate, polyurethane, polyvinyl acetate, polyethylene acetate, ethylene vinylchloride co-polymers, polyethylene, polypropylene, polyesters, co-polymers of styrene maleic anhydride salts, or mixtures thereof.

2. The heat sealable coating according to claim 1, wherein the tackifying agent is selected from acrylic emulsions, polyethylene acrylate, rosin resin and its derivatives, or low molecular weight polyethylenes.

3. The heat sealable coating according to claim 1 wherein the polymer with a Tg lower than −20° C. and a molecular weight above 25000 Da is selected from the group of natural rubber, polyacrylate, polystyrene butadiene, polybutene, polyisobutene, or polyisoprene.

4. The heat sealable coating according to claim 3 wherein the polymer with a Tg lower than −20° C. and a molecular weight above 25000 Da is present in between 15 and 40 wt %.

5. The heat sealable coating according to claim 1 wherein the tackifying agent is present between 10 and 30 wt %.

6. The heat sealable coating according to claim 1, wherein the coating layer does not comprise an anti-blocking agent.

7. The heat sealable coating according to claim 1 further comprising a cyclic imide co-polymer present between 12 and 30 wt %.

8. The heat sealable coating according to claim 1, further comprising silicone, a polyethylene emulsion, a polypropene emulsion, or a polyolefin with a melting temperature above 100° C., present in between 12 and 30 wt %.

9. A heat sealable substrate for making drinking cups or food boxes comprising a substrate coated with a heat sealable coating according to claim 1.

10. The heat sealable substrate according to claim 9, wherein the heat sealable coating, further comprises a cyclic imide co-polymer present between 12 and 30 wt %.

11. The heat sealable substrate according to claim 9, comprising the substrate first coated with a water repellent coating and thereafter coated with the heat sealable coating.

12. The heat sealable substrate according to claim 9 wherein the substrate is paper or card board.

13. The heat sealable substrate according to claim 10 wherein the drinking cups or food boxes are hot drinking cups or hot food boxes.

14. A method of forming a heat sealable substrate for making drinking cups or food boxes, wherein the method comprises coating a substrate with a heat scalable coating according to claim 1.

15. The method according to claim 14, wherein the method comprises forming the heat sealable substrate as a drinking cup or food box.

16. The heat sealable coating of claim 1, wherein the other adhesive binder(s) comprise polyvinyl acetate.

17. The heat sealable coating according to claim 1, wherein the tackifying agent is polyethylene acrylate.

18. The heat sealable coating according to claim 1 wherein the polymer with a Tg lower than −20° C. and a molecular weight above 25000 Da is natural rubber.

19. The heat sealable coating according to claim 3 wherein the polymer with a Tg lower than −20° C. and a molecular weight above 25000 Da is present in between 15 and 35 wt % and wherein the tackifying agent is present between 15 and 28 wt %.
